(19) United States
(12) Patent Application Publication
(10) Pub. No.: US 2006/0060696 A1
(43) Pub. Date: Mar. 23, 2006

(54) Link between the wing and canard for flutter reduction

(76) Inventor: Clifford B. Cordy JR., Reno, NV (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/926,455

(22) Filed: Aug. 26, 2004

(51) Int. Cl. B64C 5/04

(52) U.S. Cl. 244/45 A

(57) ABSTRACT

The efficiency of a canard airplane increases with increasing aspect ratio of the canard. As the aspect ratios of the canard and wing increase, it becomes increasingly difficult to avoid flutter at high speed. The basic modes of vibration in flutter generally include torsion in the member that is fluttering. A link between the wing and canard is added to greatly increase the torsional stiffness of both the wing and canard, with a corresponding reduction in the tendency of either of them to flutter. The link is an aerodynamic shape, much smaller than the wing or canard, that supports little static load in flight.

### RELATED APPLICATIONS

NONE

### FEDERALLY SPONSORED RESEARCH OR DEVELOPMENT

NONE

### BACKGROUND

In the design of a canard airplane, it is desirable for the canard to have a large aspect ratio. For aerodynamic reasons, the plane will be faster and more efficient if the aspect ratio of the canard is larger. For many reasons, it is desirable for an airplane to be efficient and fly fast. The combination of high speed and high aspect ratio increases the tendency to flutter. Flutter is fatal and cannot be tolerated. The maximum aspect ratio of the canard of a fast airplane is limited by flutter considerations, not loading considerations. Torsional flexure in the wing and canard are major factors in the tendency of the system to flutter. Torsion in both the wing and canard can be greatly reduced, to the point of being almost eliminated, by connecting the two with a stiff link. Never before has a canard airplane been built with a link between the canard and wing designed to eliminate torsional flexure.

### SUMMARY

A link between the wing and canard can greatly reduce the torsional flexure of both the wing and canard. To be effective, said link must be mounted toward the ends of the wing and canard, and it may be mounted at the ends of the wing and canard. It is not necessary for the wing and canard to be the same length and the link does not need to be mounted at the end of either. The link may also serve as a winglet for the wing and/or canard, helping to reduce tip turbulence and improving efficiency.

### BRIEF DESCRIPTION OF THE ILLUSTRATIONS

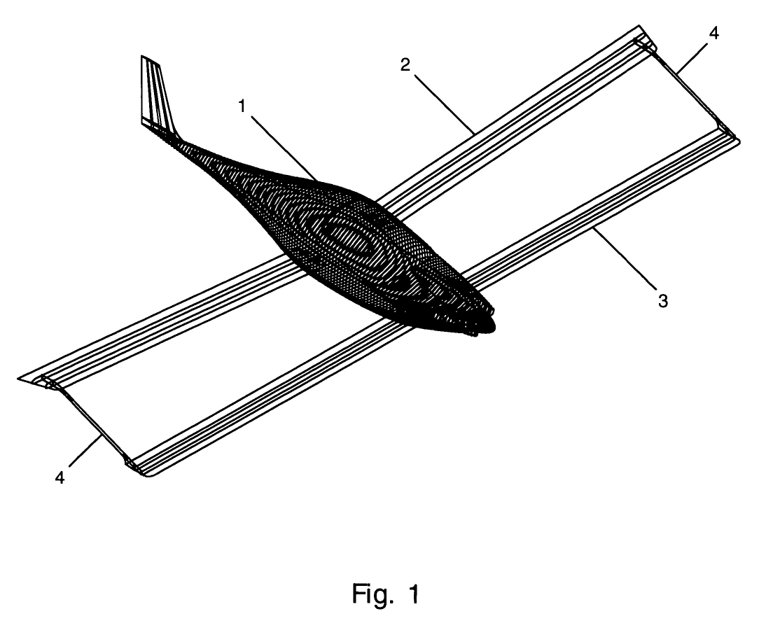

FIG. 1 is an isometric view of an airplane with a high aspect ratio canard, and a fairly high aspect ratio wing, in which a link has been added between the wing and canard to greatly increase torsional rigidity of both.

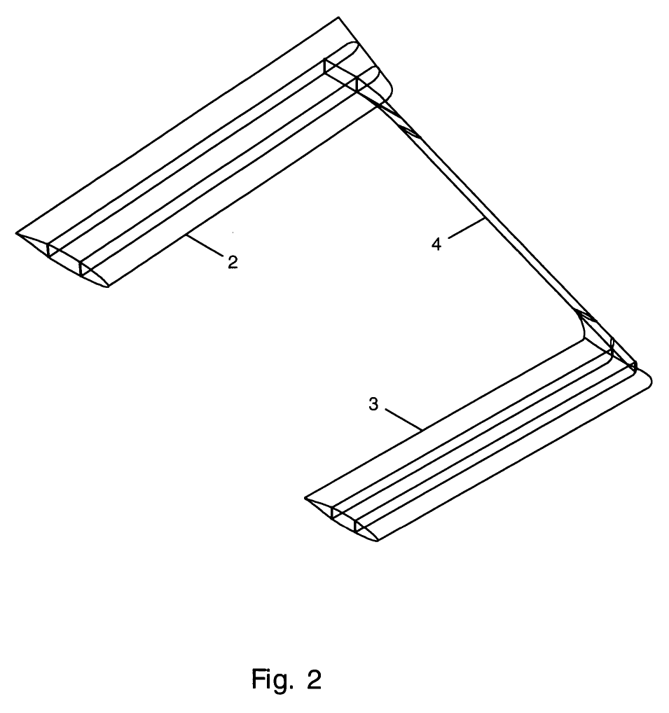

FIG. 2 is a detail of FIG. 1 showing only the link and the ends of the wing and canard.

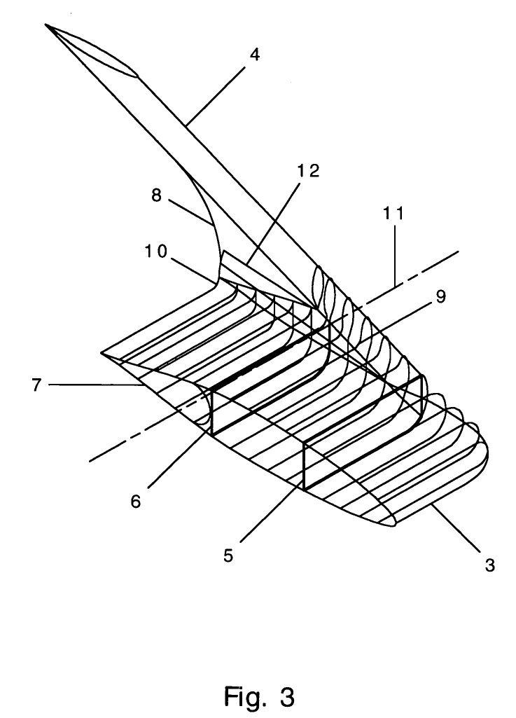

FIG. 3 is a expanded detail of the tip of the canard showing a connection between the link and the canard structure. In FIG. 3, the link is also functioning as a winglet. FIG. 3 also shows a means for the elevator to move efficiently thru its range of motion in normal flight while maintaining the winglet function of the link.

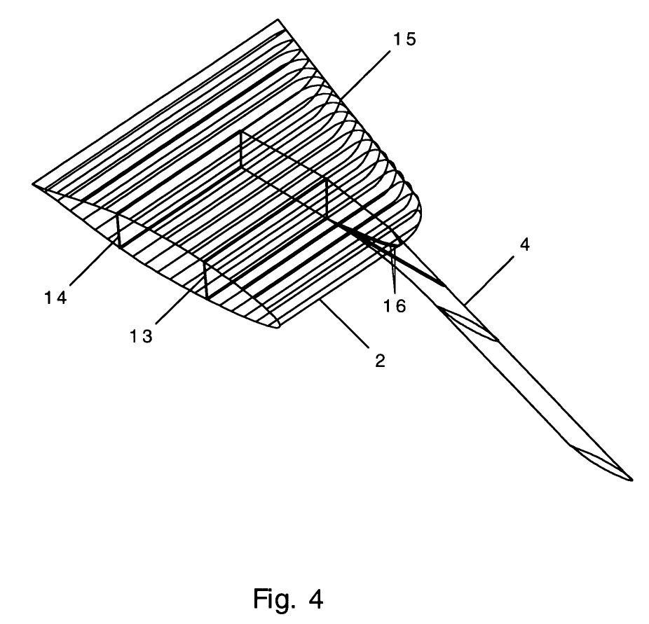

FIG. 4 is an expanded detail of the tip of the wing showing a connection between the link and the wing structure. In FIG. 4, the wing has a conventional tip and the link does not interfere with that.

### DETAILED DESCRIPTION OF THIS INVENTION

FIG. 1 is an isometric drawing of an airplane (1) with high aspect ratio wing (2) and canard (3). To greatly increase the torsional stiffness of the combination of wing (2) and canard (3), link (4) is added between the two.

FIG. 2 is a detail of link (4) between wing (2) and canard (3). This gives a better appreciation of the relative positions and sizes of the various members in a realistic application.

FIG. 3 is a detail showing the end of canard (3) and the lower part of link (4). A canard will normally contain one or more spars. In this drawing two spars are shown, central spar (5) and rear spar (6). Link (4) is firmly attached to spars (5 and 6), preventing the end of canard (3) from twisting appreciably. To improve aerodynamics, it is desirable to add a fairing (9) between the top surface of canard (3) and link (4). In this depiction, link (4) also serves as a winglet, preventing air from flowing around the aft tip of canard (3), from the high pressure region below canard (3) to the low pressure region above it. This increases aerodynamic efficiency by reducing wing tip turbulence.

An elevator (7) will always be attached to the trailing edge of the canard (3). Normally, elevator (7) will extend much of the length of canard (3). As shown here, elevator (7) extends to the end of canard (3). Obviously link (4) must be shaped and/or located in such a way that it does not interfere with the required travel of elevator (7), which typically rotates thru an angle of ±20° from its neutral position. Elevator (7) rotates around axis (11). In FIG. 3, Elevator (7) can rotate up 20° without touching link (4).

In this particular embodyment, plate (8) is added to the trailing edge of link (4) in order to effectively form a seal between link (4) and the end of elevator (7). It is desirable to have another fairing (10) between elevator (7) and plate (8). Above fairing (10), elevator (7) extends upward to its end (12) to complete the seal with plate (8) thru the range of travel of elevator (7) that is encountered in normal flight. Furthermore, end (12) of elevator (7) will not hit link (4) at a full upward deflection of 20°. Plate (8) and end (12) of elevator (7) are thin flat surfaces, essentially two dimensional in the scale of this drawing.

At large up deflections of elevator (7), the aft part of plate (8) will extend below the top of elevator fairing (10). At large down deflections of elevator (7), the aft part of top (12) of elevator (7) will not reach the bottom of plate (8). This decreases the aerodynamic efficiency of this assembly. However it is rare that large elevator deflections are used at the high speeds where aerodynamic efficiency is critical.

FIG. 4 shows the attachment of link (4) to wing (2). A wing will normally contain one or more spars. In this drawing two spars are shown, central spar (13) and rear spar (14). Link (4) is firmly attached to spars (13 and 14), preventing the end of wing (2) from twisting appreciably. A movable element, functioning as a flap or aileron, may be attached to the trailing edge of wing (2), and may extend to the end of wing (2). By necessity, such a movable element would lie entirely behind rear wing spar (14) and would not affect link (4) or its connection to wing (2).

In FIG. 4, wing tip (14) is a fairly conventional shape, and it extends outboard of link (4). Alternatively, the end of wing (2) may be nearly square, end in droops, or have winglets, either up or down. The wing tip configuration has no appreciable effect on the design of link (4) or its attachment to wing (2).

To reduce intersection drag, link (4) is shown tapering to a thin cross section near wing (2). Link (4) functions as an end supported beam. As such, stresses in link (4) are highest toward the center and decrease to zero at the ends. Ideally, there would be a simple fairing at the intersection (16) between link (4) and wing (2). For the sake of clarity, no such fairing is shown in FIG. 4.

In all figures, the wing and canard are essentially the same span, the chord of the wing somewhat exceeds the chord of the canard, and the link is connected essentially between the tips of each. None of these conditions are necessary. The two lifting surfaces may be of considerably different spans. In fact, it is common that the wing is longer than the canard, but the opposite can also be true. Some canard airplanes have canards with greater chord than the wing. The link does not need to be connected to the tip of either. In fact, the torsional rigidity of the wing or canard is maximized if the link is connected at a location about 80% of the distance from the fuselage to the tip. The resistance to flutter is increased if the resonant frequencies of the wing and canard are not related by a simple fraction. The resistance to flutter is further increased if the resonant frequency of the fraction of each lifting surface outboard of the link and the resonant frequency of the fraction of that lifting surface inboard of the link are not related by a simple fraction. In general, the structure of the canard is simpler if the link is connected at the tip. The drag at the intersection between the link and the wing or canard is minimized if the link is at the tip of the lifting member. In the figures, the wing is shown with dihedral and the canard is shown as flat. In reality, the the wing and canard may have any combination of dihedral, anhedral, or neither.

The above paragraph is included as a teaching aid. The claims of this patent include all the above possibilities, but are not limited to them.

Note that the link is vertical, or nearly so. It does not provide lift. Therefore, its thickness (in the direction of the axis of the canard) need be only great enough to avoid buckling and flutter. The chord of the link needs to be large enough to provide enough stiffness to suppress any rotation of the wing or canard tip around its axis. In a well designed wing, the spar(s) are located such that there is little tendency of the wing to twist under static loading. In this case, the link has no static load and needs only to suppress the oscillatory motions of the wing and canard associated with potential flutter. Thus the link can be a thin, efficient airfoil with a chord much shorter than the wing or canard. An adequate link can be designed that has a drag less than 1% of the drag of the lifting surfaces, thus having no detectable effect on the top speed or fuel consumption of the airplane. It does provide a great safety margin against flutter in high speed flight.

### This is not a Biplane

It is possible for a biplane to be a canard airplane also. The Wright Flyer is one example. But that requires the plane to have two wings, one above the other, in addition to a canard. This airplane is not a biplane. It does not meet the conventional sense of the word “biplane”. Nor does it meet the definition of “biplane” by the rules of airplane racing.

1. An airplane comprising a wing and canard, the airplane further comprising a link between said wing and canard, said link having a thickness smaller than twice the thickness of said canard, said link being attached to said wing and canard in excess of 70% of the distance from the fuselage to the tip of the shorter of said wing or said canard.

2. An airplane as in claim 1 in which said canard comprises one or more spars, said link connecting into said spar structure of said canard.

3. An airplane as in claim 1 in which said wing comprises one or more spars, said link connecting into said spar structure of said wing.

4. An airplane as in claim 1 in which said link is mounted at the tip of said canard and serves as a winglet for said canard.

5. An airplane as in claim 1 in which said canard comprises an elevator that extends to said link, said elevator and said link shaped such that at least 75% of the chord of the end of said elevator remains within 2 cm of said link over a range of elevator positions of at lease +2 degrees from the neutral position of said elevator.
